(19) United States
(12) Patent Application Publication
(10) Pub. No.: US 2009/0164921 A1
(43) Pub. Date: Jun. 25, 2009

(54) METHOD AND SYSTEM FOR PERSONALIZING DATA ITEM TABLES

(75) Inventors: Dirk Wagner, Schiffweiler (DE); Frank Wittig, Spiesen Elversberg (DE)

Correspondence Address: BRAKE HUGHES BELLERMANN LLP, C/O CPA Global, P.O. BOX 52050, MINNEAPOLIS, MN, 55402, US

(73) Assignee: SAP AG, Walldorf (DE)

(21) Appl. No.: 11/961,448

(22) Filed: Dec. 20, 2007

(51) Int. Cl. G06F 3/00

(52) U.S. Cl. 715/762

(57) ABSTRACT

Methods and systems are described for personalizing data item tables and for previewing table designs. An example system may include a personalized table manager including a table layout manager configured to obtain table layout information associated with a personalized data item table from a first data source, a data item attribute manager configured to obtain data item attribute information associated with the personalized data item table from a second data source, and a test view generator configured to generate a test view associated with the personalized data item table, the test view including a graphical representation of the data item attribute information displayed in accordance with the table layout information.

### TECHNICAL FIELD

This description relates to techniques for personalizing data item tables and for previewing table designs.

### BACKGROUND

Relationships among entities such as businesses and customers may be developed or improved by personalizing communications among target recipients of messages or other communication items shared among the entities. For example, many businesses recognize that personalized customer service may encourage customers to continue and expand a business relationship over time, thus driving new growth and helping the business to achieve or maintain competitive agility.

As an example, customer relationship management (CRM) may involve acquiring and retaining customers or other types of business partners, improving loyalty and gaining insight among such business partners, and implementing strategies focused on such customers or business partners.

Developing personalized communications may involve obtaining information regarding target recipients of messages. For example, a business may obtain personal information regarding customers or potential customers such as their name, contact information, purchase history and/or personal preferences. Further, the business may obtain information associated with data items such as products that the customers or potential customers may find interesting. The business may then develop marketing campaigns or newsletters that may be personalized for each individual target recipient based on the obtained information. Such information may more conveniently be presented to a reader via a table such as a product table. The business may wish to customize the “look and feel” of such tables, and to customize selections of which data items or products should be presented via such tables. However, it may be impractical for businesses with a large number of customers, potential customers or other desired target recipients of communication items to manually generate each such personalized communication item.

Thus, it may be desirable to provide techniques for personalizing data item tables.

### SUMMARY

According to one general aspect, a system includes a personalized table manager including a table layout manager configured to obtain table layout information associated with a personalized data item table from a first data source, a data item attribute manager configured to obtain data item attribute information associated with the personalized data item table from a second data source, and a test view generator configured to generate a test view associated with the personalized data item table, the test view including a graphical representation of the data item attribute information displayed in accordance with the table layout information.

According to another aspect, a method includes obtaining table layout information associated with a personalized data item table from a first data source. The method further includes obtaining data item attribute information associated with the personalized data item table from a second data source, and generating a test view associated with the personalized data item table, the test view including a graphical representation of the data item attribute information displayed in accordance with the table layout information.

According to yet another aspect, a computer program product may be tangibly embodied on a computer-readable medium, and may be configured to cause a data processing apparatus to obtain table layout information associated with a personalized data item table from a first data source, obtain data item attribute information associated with the personalized data item table from a second data source, and generate a test view associated with the personalized data item table, the test view including a graphical representation of the data item attribute information displayed in accordance with the table layout information.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system for personalizing communication items.

FIG. 2 is a flowchart illustrating an operation of the system of FIG. 1 according to an example embodiment.

FIG. 3 is a screen shot illustrating a table editing view according to an example embodiment.

FIG. 4 is a screen shot illustrating a table layout editing view according to an example embodiment.

FIG. 5 is a screen shot illustrating a source code table layout view according to an example embodiment.

FIG. 6 is a screen shot illustrating an example test view associated with a table layout according to an example embodiment.

FIG. 7 is a screen shot illustrating a test message according to an example embodiment.

FIG. 8 is a flow diagram illustrating a flow of layout specification and content specification associated with a personalized data item table according to an example embodiment.

FIG. 9 is a block diagram illustrating relationships among layout specification, content specification, and table preview associated with a personalized data item table according to an example embodiment.

FIG. 10 is a block diagram illustrating an example relationship between content specification and table preview associated with a personalized data item table according to an example embodiment.

FIG. 11 is a block diagram of a system for personalizing communication items according to an example embodiment.

### DETAILED DESCRIPTION

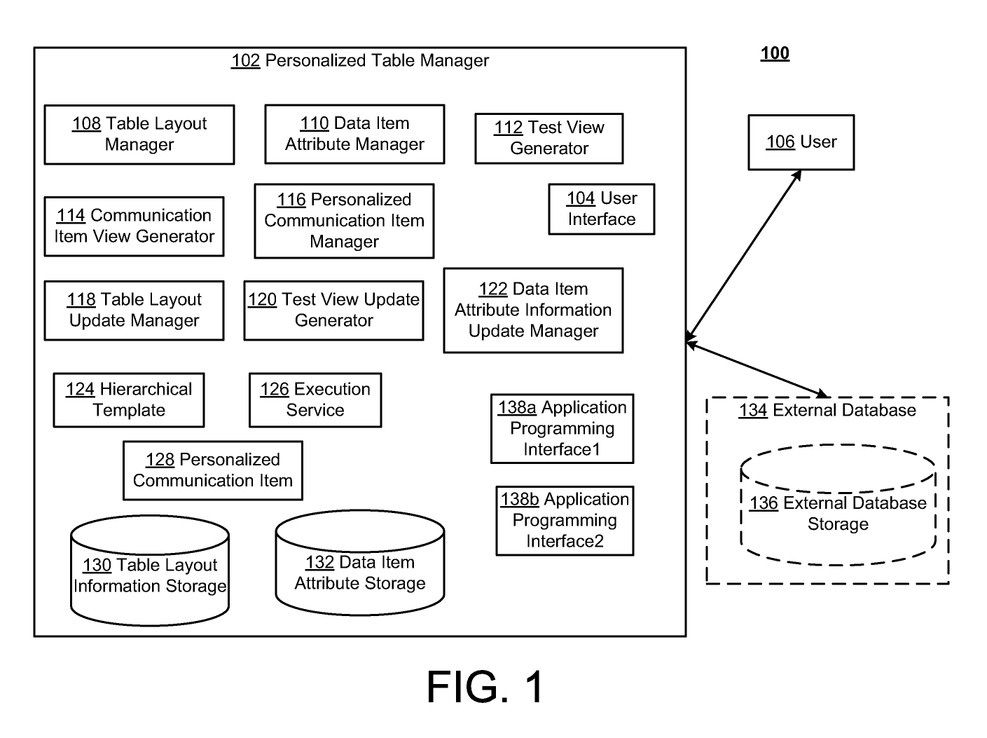

FIG. 1 is a block diagram of a system 100 for personalizing data item tables and for previewing table designs according to an example embodiment. In the example of FIG. 1, a personalized table manager 102 includes various processing engines that may be configured to manage personalized data item tables. According to an example embodiment, the personalized table manager 102 may include a user interface 104 configured to manage communication with a user 106.

According to an example embodiment, the personalized table manager 102 may include a table layout manager 108 configured to obtain table layout information associated with a personalized data item table from a first data source. For example, table layout information may include formatting attribute information such as fonts, font sizes, background colors, border attributes, etc. For example, the first data source may include a user entering the layout information via a user interface as discussed below.

According to an example embodiment, the personalized table manager 102 may include a data item attribute manager 110 configured to obtain data item attribute information associated with the personalized data item table from a second data source. For example, data item attribute information may include descriptions, prices, or rebate information associated with various products of interest to a customer or potential customer. For example, the second data source may include a user entering the data item attribute information via a second user interface as discussed below.

According to an example embodiment, the personalized table manager 102 may include a test view generator 112 configured to generate a test view associated with the personalized data item table, the test view including a graphical representation of the data item attribute information displayed in accordance with the table layout information. For example, the test view may include a view of a designed table that is shown based on background colors, borders, and fonts specified in the table layout information, and may include a view of the data item attribute information formatted in accordance with the table layout information. For example, the test view may include a view indicating that a product ID and product description may be included in the table at execution time, the test view including the attributes displayed in the font colors, borders, and other layout information as obtained by the test view generator 112.

According to an example embodiment, the personalized table manager 102 may include a communication item view generator 114 configured to generate a communication item view associated with the personalized data item table, the communication item view including a graphical representation of values of one or more data items associated with the data item attribute information displayed in accordance with the table layout information. For example, the communication item view may include actual product data substituted in for the attribute values, in accordance with the table layout information. For example, the communication item view may be generated at execution time for sending a product table to a customer or potential customer.

According to an example embodiment, the communication item view generator 114 may be configured to generate a communication item view associated with the personalized data item table, the communication item view including a graphical representation of values of one or more data items associated with the data item attribute information displayed in accordance with the table layout information based on retrieving and processing the values, the table layout information, and the data item attribute information.

According to an example embodiment, the personalized table manager 102 may include a personalized communication item manager 116 configured to provide a personalized communication item including the communication item view. For example, the personalized communication item manager 116 may generate an email including a product table formatted in accordance with the table layout information, and with values filled in, in accordance with the data item attribute information.

According to an example embodiment, the table layout manager 108 may be configured to obtain the table layout information associated with the personalized data item table from a first application, the data item attribute manager 110 may be configured to obtain the data item attribute information associated with the personalized data item table from a second application, and the test view generator 112 may be configured to generate the test view associated with the personalized data item table, the test view including a graphical representation of the data item attribute information displayed in accordance with the table layout information, based on retrieving and processing the table layout information and the data item attribute information.

According to an example embodiment, the table layout manager 108 may be configured to obtain the table layout information based on obtaining one or more table format attribute values, including one or more of a table border format attribute, a cell padding format attribute, a font attribute, an alignment attribute, a color attribute, or a size attribute associated with the personalized data item table, from a first application. According to an example embodiment, the data item attribute manager 110 may be configured to obtain the data item attribute information based on obtaining one or more data item attributes, including one or more of a data item identifier (ID), a data item description, a data item category, a data item category type, or a data item price associated with data items associated with the personalized data item table, from a second application, and the test view generator 112 may be configured to generate the test view associated with the personalized data item table, the test view including a graphical representation of the data item attribute information displayed in accordance with the table layout information, based on retrieving and processing the table layout information and the data item attribute information.

According to an example embodiment, the table layout manager 108 may be configured to obtain the table layout information based on obtaining table layout information associated with a personalized product table from a first application. According to an example embodiment, the data item attribute manager 110 may be configured to obtain the data item attribute information based on obtaining product attribute information associated with the personalized product table from a second application, and the test view generator 112 may be configured to generate the test view based on generating a test view associated with the personalized product table, the test view including a graphical representation of the product attribute information displayed in accordance with the table layout information, based on retrieving and processing the table layout information and the product attribute information.

According to an example embodiment, the personalized table manager 102 may include a table layout update manager 118 configured to obtain updated table layout information via a table layout user interface application. For example, a user may wish to update table layout information, for example, after previewing a personalized table that has been designed via the personalized table manager 102. For example, the user 106 may decide to modify a font type.

According to an example embodiment, the personalized table manager 102 may include a test view update generator 120 configured to generate an updated test view associated with the personalized data item table, the updated test view including a graphical representation of the data item attribute information displayed in accordance with the updated table layout information. For example, the user 106 may view the personalized table after entering updated information with regard to the table layout information or the data item attribute information.

According to an example embodiment, the personalized table manager 102 may include a data item attribute information update manager 122 configured to obtain updated data item attribute information via a data item attribute user interface application. For example, the user 106 may add, delete, or modify data item attribute information, for example, by adding a product category.

According to an example embodiment, the test view update generator 120 may be configured to generate an updated test view associated with the personalized data item table, the updated test view including a graphical representation of the data item attribute information displayed in accordance with the updated table data item attribute information.

The personalized communication manager 102 may further include a hierarchical template 124 including a description of an execution service 126 associated with a personalized communication item 128 based on the template information, wherein the execution service 126 may be configured to provide the personalized communication item 128 to a target recipient based on the hierarchical template 124.

According to an example embodiment, the table layout information may be stored in a table layout information storage area 130. According to an example embodiment, the data item attribute information may be stored in a data item attribute storage area 132.

According to an example embodiment, the personalized communication item 128 may include one or more of an email message, a facsimile message, a letter, a personalized web page, or an electronic text message. One skilled in the art of data processing will appreciate that many other forms of personalized communication may also be used without departing from the spirit of the present discussion.

According to an example embodiment, an external database 134 may include an external database storage area 136 for storing database information external to the personalized table manager 102. For example, the user 106 may wish to generate personalized communication items 128 based at least in part on information stored in the external database 134.

According to an example embodiment, a user such as a business may generate a personalized contact with its customers as part of marketing campaigns. For example, the personalized contact may include individual product offerings, or may be realized via an appropriate choice of a correspondence language, salutation, first name, name, address, or other personalized features. Such a personalized approach may contribute significantly, for example, to an increase in customer loyalty from a business perspective.

According to an example embodiment, personalizable templates of marketing documents may be designed for many different types of contact channels, for example, an email message, a facsimile message, a letter, a personalized web page, a Short Message Service (SMS) message, a message included in a file export, or an electronic text message.

According to an example embodiment, a designer of a template may test the template, for example by sending a test email message to himself/herself. For example, the designer may test the template immediately after creation or edit via a user interface such as the user interface 104.

According to an example embodiment, interfaces such as Application Programming Interfaces (APIs) 138a, 138b may provide extensions by arbitrary further personalization features. According to an example embodiment, industry standards such as Hypertext Markup Language (HTML) and eXtensible Markup Language (XML) may be used to ensure realizations of such extensions.

According to an example embodiment, the system 100 may provide personalized tables for inclusion in personalized mails associated with marketing by a user.

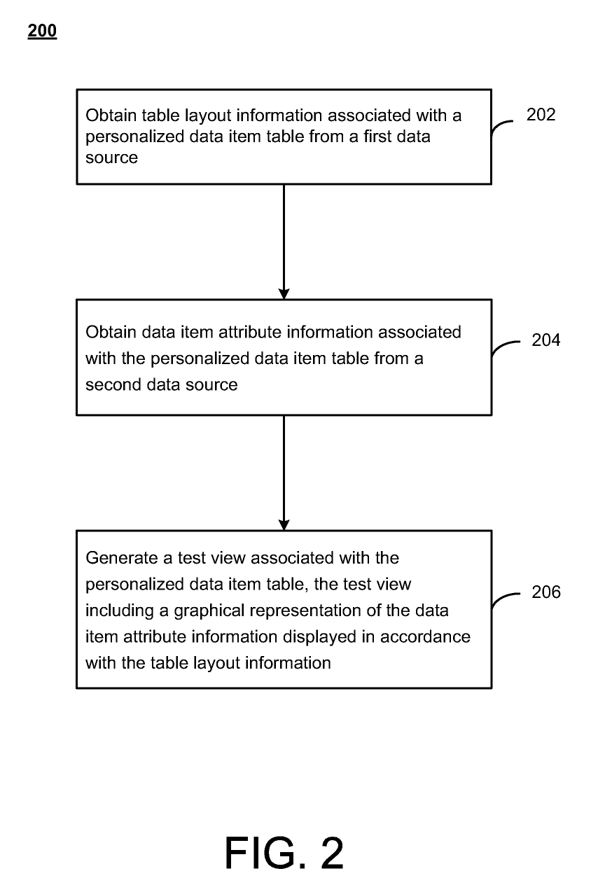

FIG. 2 is a flowchart 200 illustrating an operation of the system of FIG. 1. According to an example embodiment, a method may include obtaining table layout information associated with a personalized data item table from a first data source (202). For example, the table layout manager 108 may obtain table layout information associated with a personalized data item table from a first data source as discussed previously.

According to an example embodiment, the method may further include obtaining data item attribute information associated with the personalized data item table from a second data source (204). For example, the data item attribute manager 110 may obtain data item attribute information associated with the personalized data item table from a second data source, as discussed previously.

According to an example embodiment, the method may further include generating a test view associated with the personalized data item table, the test view including a graphical representation of the data item attribute information displayed in accordance with the table layout information (206). For example, the test view generator 112 may generate a test view associated with the personalized data item table, the test view including a graphical representation of the data item attribute information displayed in accordance with the table layout information, as discussed previously.

According to an example embodiment, the method may further include generating a communication item view associated with the personalized data item table, the communication item view including a graphical representation of values of one or more data items associated with the data item attribute information displayed in accordance with the table layout information. For example, the communication item view generator 114 may generate a communication item view associated with the personalized data item table, the communication item view including a graphical representation of values of one or more data items associated with the data item attribute information displayed in accordance with the table layout information, as discussed previously.

According to an example embodiment, the method may further include generating a communication item view associated with the personalized data item table, the communication item view including a graphical representation of values of one or more data items associated with the data item attribute information displayed in accordance with the table layout information based on retrieving and processing the values, the table layout information, and the data item attribute information, and providing a personalized communication item including the communication item view.

According to an example embodiment, the obtaining the table layout information may include obtaining table layout information associated with the personalized data item table from a first application. According to an example embodiment, the obtaining the data item attribute information may include obtaining data item attribute information associated with the personalized data item table from a second application. According to an example embodiment, the generating the test view may include generating a test view associated with the personalized data item table, the test view including a graphical representation of the data item attribute information displayed in accordance with the table layout information, based on retrieving and processing the table layout information and the data item attribute information.

According to an example embodiment, the method may further include obtaining updated table layout information via a table layout user interface application, and generating an updated test view associated with the personalized data item table, the updated test view including a graphical representation of the data item attribute information displayed in accordance with the updated table layout information. For example, the table layout update manager 118 may obtain updated table layout information via a table layout user interface application, as discussed previously.

According to an example embodiment, the method may further include obtaining updated data item attribute information via a data item attribute user interface application, and generating an updated test view associated with the personalized table, the updated test view including a graphical representation of the updated data item attribute information displayed in accordance with the table layout information. For example, the data item attribute information update manager 122 may obtain updated data item attribute information via a data item attribute user interface application, as discussed previously. For example, the test view update generator 120 may generate an updated test view associated with the personalized data item table, the updated test view including a graphical representation of the data item attribute information displayed in accordance with the updated information, as discussed previously.

According to an example embodiment, the personalized communication item 128 may include one or more of an email message, a facsimile message, a letter, a personalized web page, a Short Message Service (SMS) message, a message included in a file export, or an electronic text message.

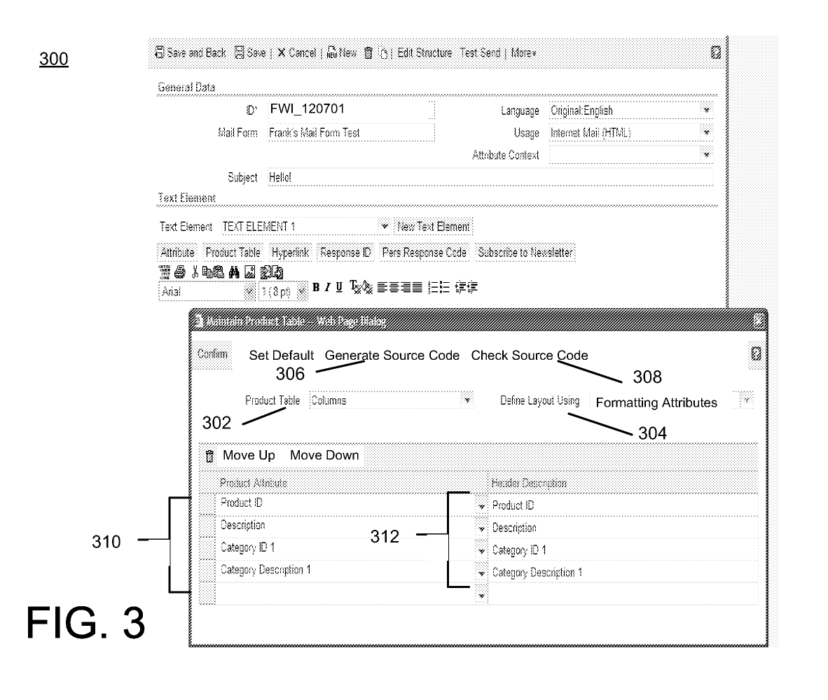

FIG. 3 is a screen shot 300 illustrating a table editing view according to an example embodiment. According to an example embodiment, if a product table 302 is included in a template or mail form, the user may specify a product, product group, product category, or product segment with which to test the product table. For example, if products are assigned to a campaign, up-to-date data associated with the products may be sent as product tables in table form in personalized communication items.

According to an example embodiment, a user may preview a product table to verify the layout of a defined product table. According to an example embodiment, details for the product attributes to be displayed in a product table may be entered in the master data for the desired products. According to an example embodiment, if details are not entered, the corresponding field in the product table may be displayed blank.

According to an example embodiment, a product table 302 may be inserted in a text element. According to an example embodiment, a user may define columns and layout 304 when setting up product tables 302. According to an example embodiment, a user may select from a variety of product attributes, such as Product ID, Description, or Unit of Measure, for display in the columns of the table. According to an example embodiment, a product attribute may be used as a header description for a column, or a user may enter a customized header description.

As shown in the example of FIG. 3, product attributes 310 Product ID, Description, Category ID 1, and Category Description 1 have been specified. Further, headers 312 Product ID, Description, Category ID 1, and Category Description 1 have also been specified.

According to an example embodiment, a user may define a layout of a product table, for example, to correspond to the user's color scheme. According to an example embodiment, if the personalized communication item is sent in plain-text format, the product table may be sent as plain text.

According to an example embodiment, a user may define a layout of a product table based on formatting attributes. For example, the layout may be defined by selecting formatting attributes from dropdown lists. For example, the user may select formatting attributes for the table in general, such as for the table border or the cell padding, and for the table header and body, such as for the font and alignment. As shown in the example of FIG. 3, the user may click “Generate Source Code” 306 after the formatting attributes have been selected.

According to an example embodiment, a user may define a layout of a product table based on HTML source code. For example, a user may define the layout by entering the HTML source code directly. As shown in the example of FIG. 3, the user may click “Check Source Code” 308 to verify syntax of the source code.

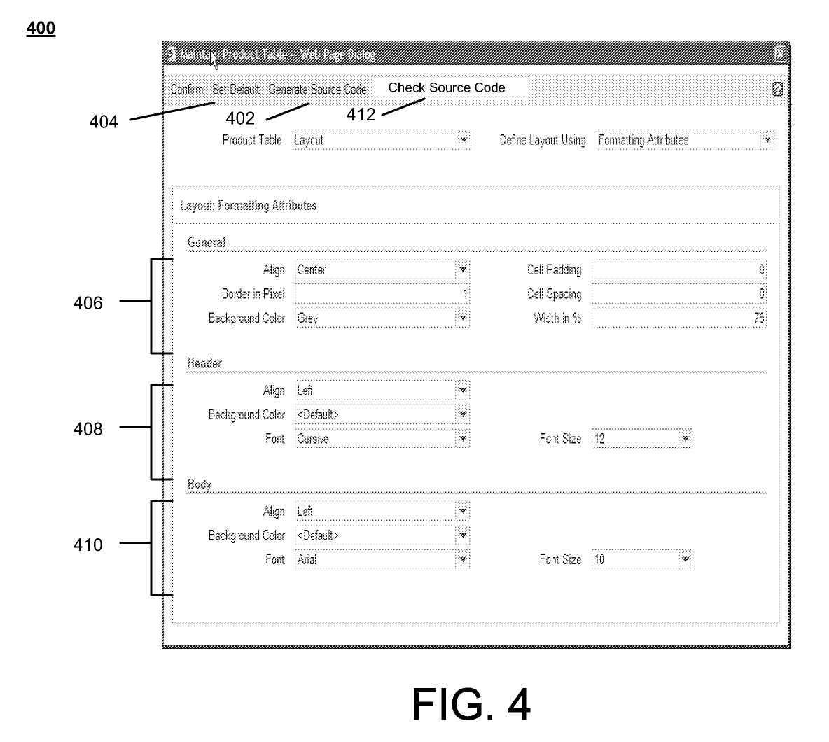

FIG. 4 is a screen shot 400 illustrating a table layout editing view according to an example embodiment. As shown in the example of FIG. 4, a user may specify the layout of an HTML table that may be included in a text element. A subset of several HTML attributes for table definition may be provided for selection by a user. After the selection, the user may generate the corresponding HTML source code via the button “Generate Source Code” 402. The user may reinitialize the HTML source code using “Set Default” 404.

As discussed previously, attributes may be obtained, for example, from a user. For example, general attributes 406 may include alignment, border (in pixels), background color, cell padding, cell spacing, or width (in %), as shown in FIG. 4.

For example, header attributes 408 may include alignment, background color, font, and font size, as shown in FIG. 4. For example, body attributes 410 may include alignment, background color, font, and font size, as shown in FIG. 4. As shown in FIG. 4, the user may select values for the attributes via pull-down menus. As shown in the example of FIG. 4, the user may click “Check Source Code” 412 to verify syntax of the source code.

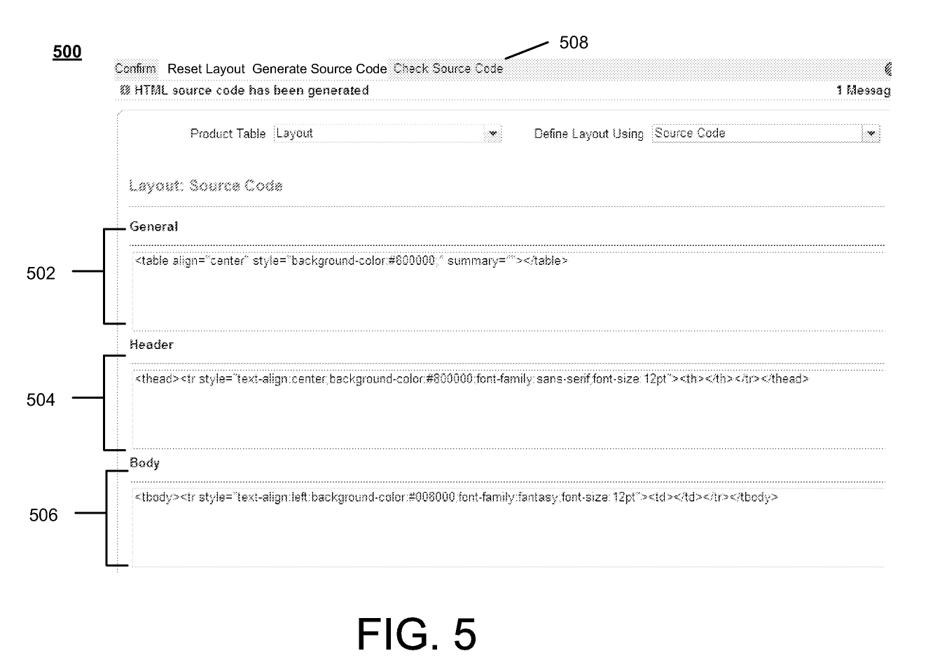

FIG. 5 is a screen shot 500 illustrating a source code table layout view according to an example embodiment. As shown in the example of FIG. 5, the source code may be manually specified and/or modified. The text area 502 corresponds to the HTML table tag <table>, the text area 504 corresponds to the HTML table tag <thead>, and the text area 506 corresponds to the HTML table tag <tbody>. A user may select a button “Check Source Code” 508 to verify syntax of the entered HTML source code.

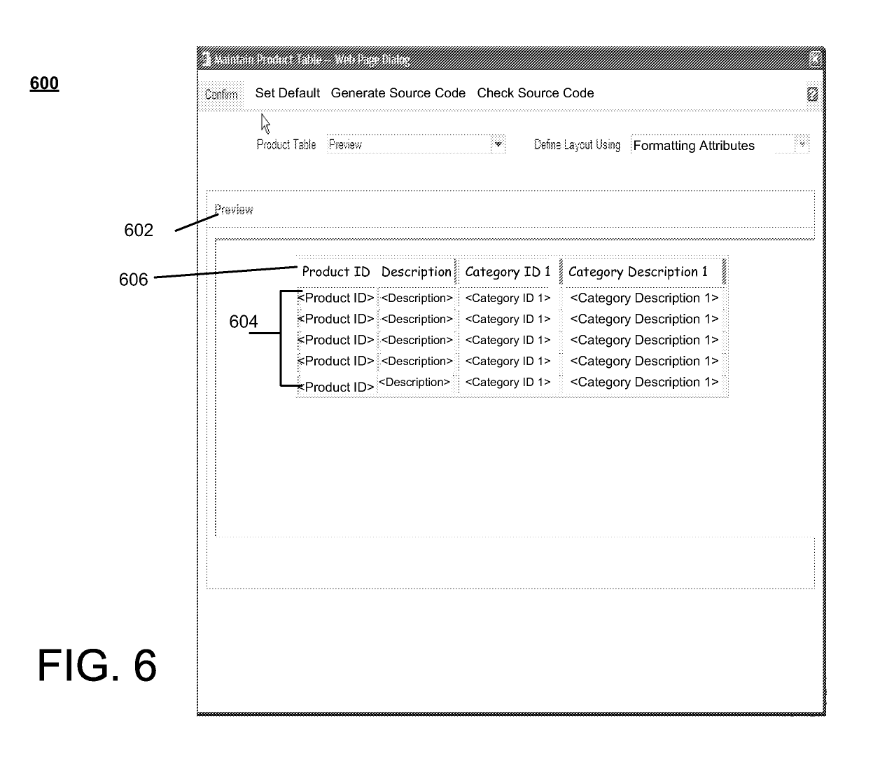

FIG. 6 is a screen shot 600 illustrating an example test view associated with a table layout according to an example embodiment. In the example of FIG. 5, a dynamically generated preview of a product table is shown as a popup. The data specified on the other views of the popup, i.e. columns and HTML layout information, is taken into account. Thus, after every change, a user may obtain a preview to determine how the table will appear in a sent message, i.e., the user may determine how the formatting attributes will appear with the described content. Although not shown in FIG. 6, the example test view may be provided with a requested background color, font color, and any other formatting attributes that the user may request. As shown in the example preview 602 of FIG. 6, headers 604 may include product ID, description, category ID, and category description 1. As further shown in the example preview 602 of FIG. 6, cells in rows 606 may include content product ID, description, category ID, and category description 1, formatted in accordance with the layout information.

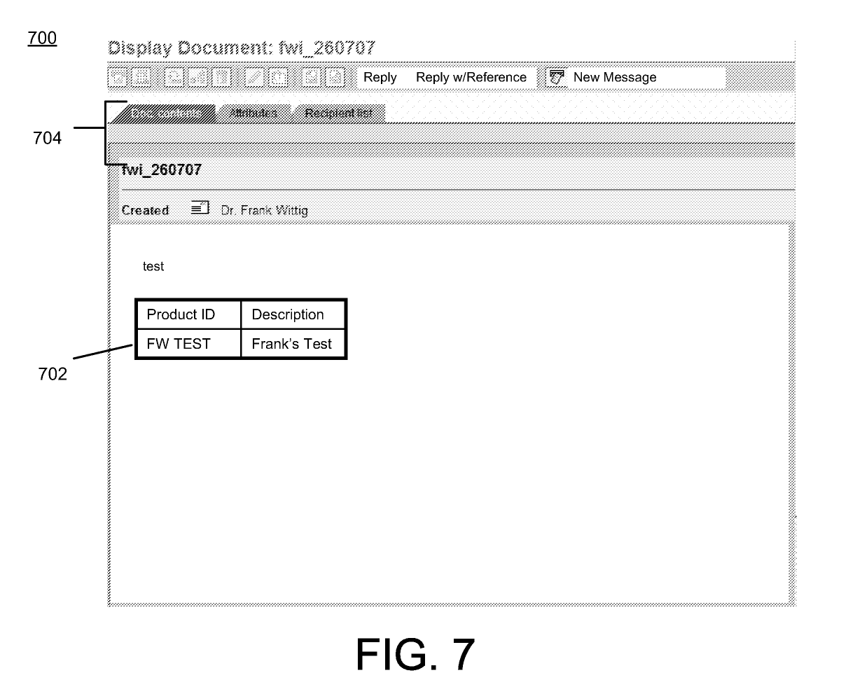

FIG. 7 is a screen shot 700 illustrating a test message 700 according to an example embodiment. According to an example embodiment, a user may preview a product table to verify the layout of a defined product table, as discussed previously. In the example shown in FIG. 7, a product table 702 may be displayed to verify that entries and formatting specified by a user may be filled into a message as desired at execution time. Further, the user may verify other document contents, attributes, and a recipient list by selecting various tabs 704.

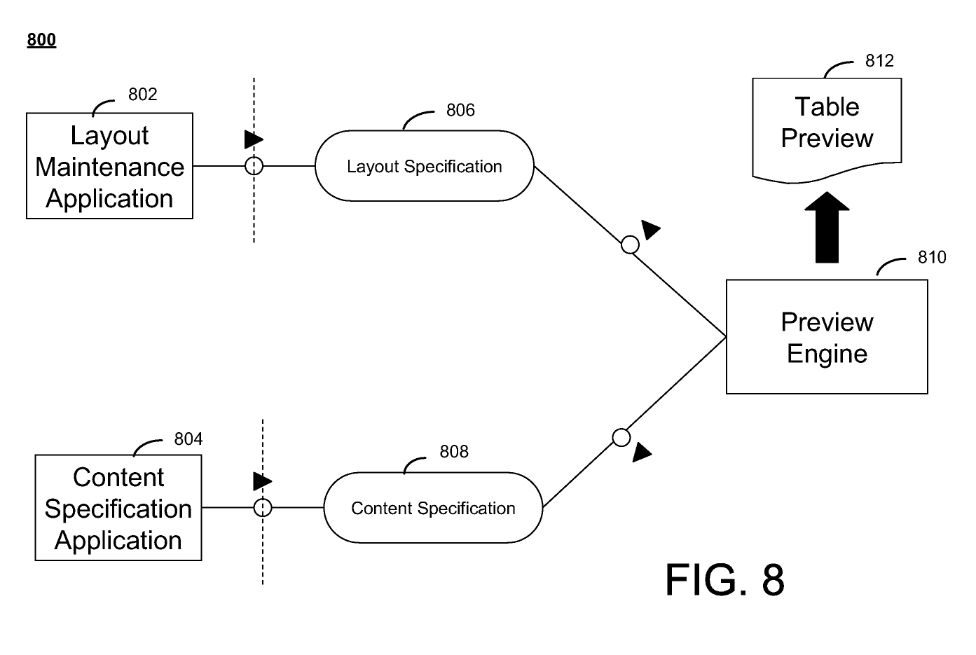

FIG. 8 is a flow diagram 800 illustrating a flow of layout specification and content specification associated with a personalized data item table according to an example embodiment. As shown in the example of FIG. 8, a layout maintenance application 802 may be used to determine and/or update a table layout, as discussed previously. Similarly, a content specification application 804, which may be separate from the layout maintenance application 802, and may be used by a different entity, may be used to determine content for a data item table, as discussed previously.

As shown in FIG. 8, the layout maintenance application 802 may generate a layout specification 806, which may include layout attributes, as discussed previously. Similarly, the content specification application 804 may generate a content specification 808, which may include content attributes, as discussed previously. The layout specification 806 and the content specification 808 may be obtained by a preview engine, for example, at the request of a user, to generate a table preview 812, as discussed previously. Thus, the layout information and the content information may be obtained from different sources, to be used in generating the table preview, or test view of the data item table.

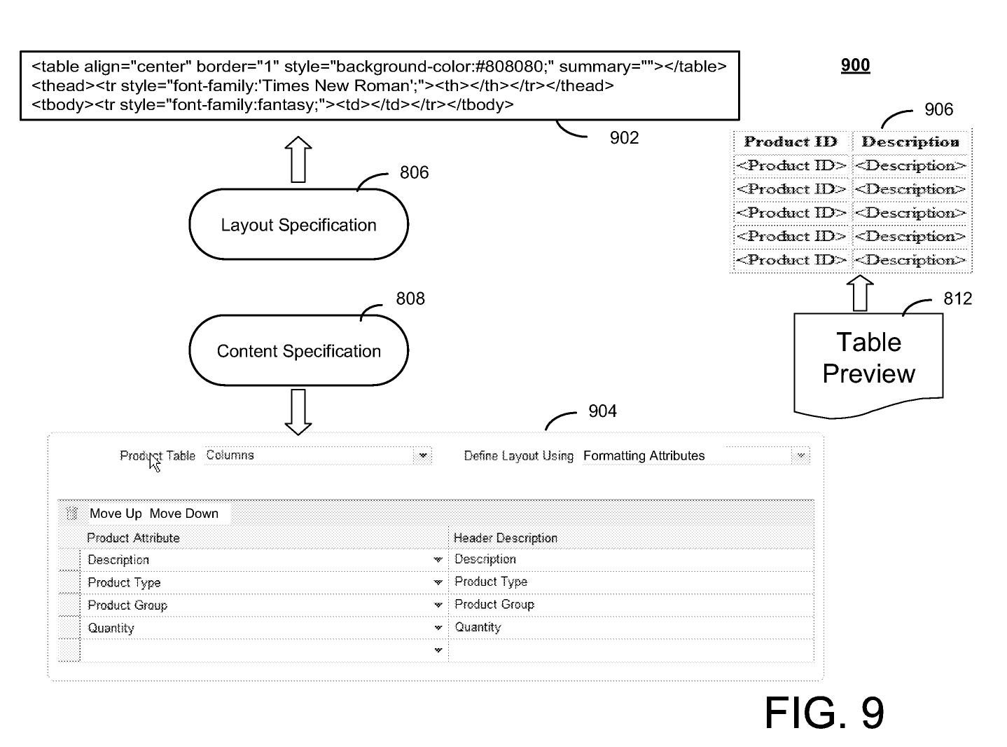

FIG. 9 is a block diagram illustrating relationships among layout specification, content specification, and table preview associated with a personalized data item table according to an example embodiment. As shown in the example of FIG. 9, the layout specification 806 may include source code such as HTML code 902 indicating the layout of the data item table. Further, the content specification 808 may be obtained via an input application 904 to obtain the attribute information as discussed previously. As shown in FIG. 9, the table preview 812 may generate a test view, or preview 906 of the data item table, e.g., a product table, so that a user may determine whether further modifications may need to be made, for example, before using the data item table or product table for a communication item.

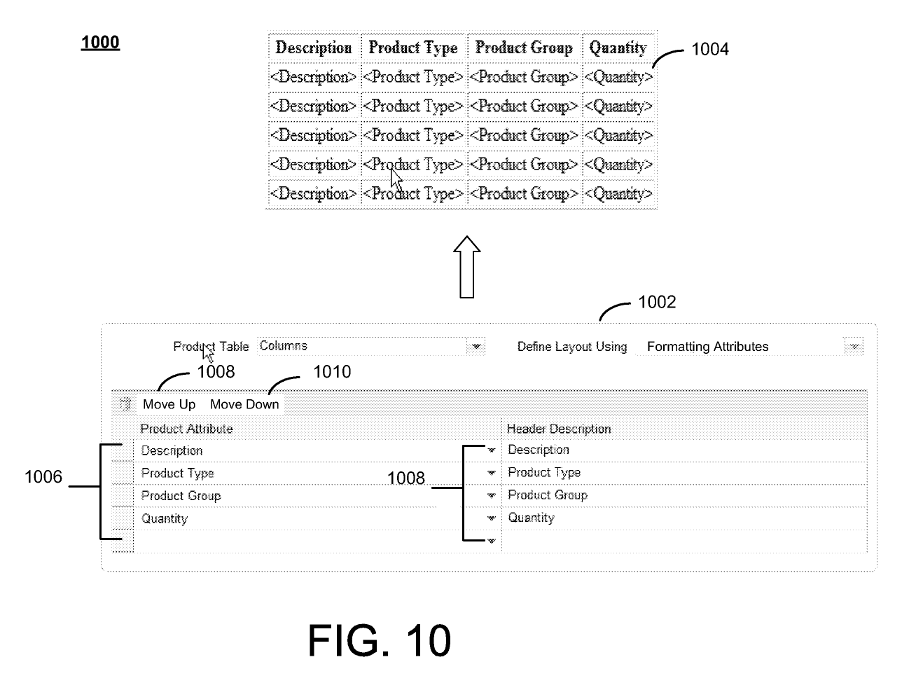

FIG. 10 is a block diagram illustrating an example relationship between content specification 1002 and table preview 1004 associated with a personalized data item table according to an example embodiment. As shown in the example of FIG. 10, product attributes 1006 may be specified as description, product type, product group, and quantity. Column headers 1008 may be described similarly. As shown in FIG. 10, the test view or table preview 1004 shows the generated test table including cell values associated with the product attribute names, i.e., description, product type, product group, and quantity. The column headers include similar names, as indicated by the content specification section 1008.

According to an example embodiment, a user may modify an order of attributes as they occur in the data item table using buttons such as “Move up” 1008 and “Move Down” 1010.

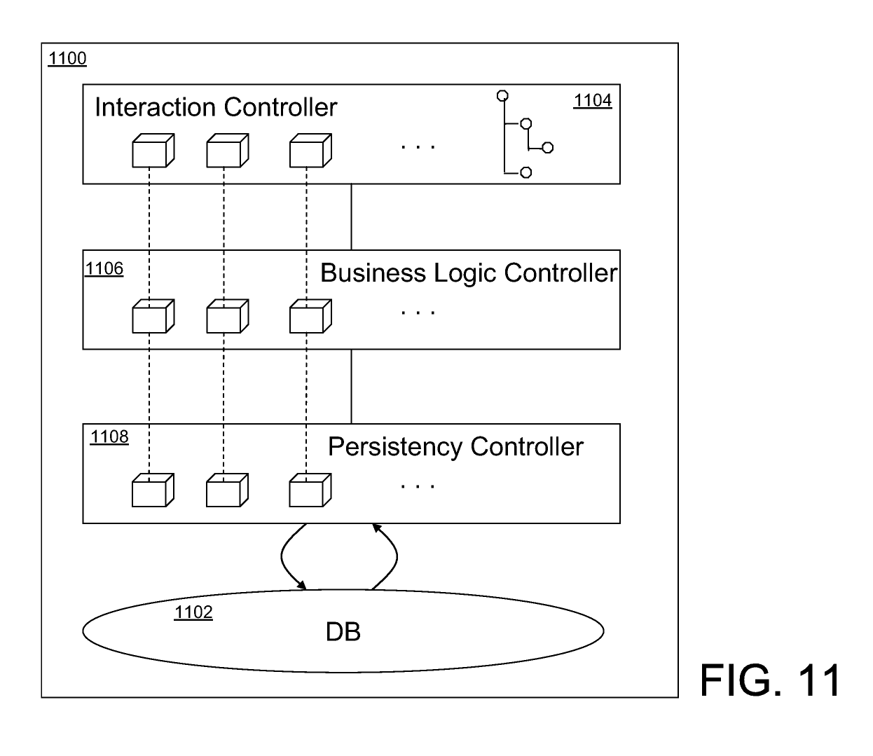

FIG. 11 is a block diagram of a system 1100 for personalizing communication items according to an example embodiment. In the example of FIG. 11, a database layer 1102 may be configured to store template information associated with a personalized communication item 128 and a template 124 including a description of an execution service 126 associated with the personalized communication item 128 based on the template information, wherein the execution service 126 is configured to provide the personalized communication item 128 to a target recipient based on the template; an interaction controller 1104 including one or more application programming interfaces and a user interface configured to receive user input associated with the template and template information; a business logic controller 1106 configured to obtain the template information via the interaction controller 1104; and a persistency controller 1108 configured to store and retrieve information associated with the database layer 1102.

According to an example embodiment, the interaction controller 1104 may be configured to receive requests for updating the template and template information. For example, the interaction controller 1104 may receive requests from a user such as the user 106 discussed previously.

According to an example embodiment, the interaction controller 1104 may be configured to receive requests for one or more of creating, reading, updating, or deleting information elements associated with the template.

According to an example embodiment, the persistency controller 1108 may be configured to store and retrieve information associated with the database layer 1102 in binary format. Thus, for example, users on different platforms may retrieve the information and view a display of the information via a format associated with the platform in use by the user.

According to an example embodiment, personalized communication items may also be executed by external agencies, for example, as a part of direct marketing activity during which a certain target group is to be personally contacted via mail, fax, SMS or email. For example, the external agencies may receive data files with the extracted customer data and may send out personalized communication items based on this data. As another example, the external agencies may contact members of the target group via calls or personal visits based on the extracted data.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A system comprising:
a personalized table manager including:
a table layout manager configured to obtain table layout information associated with a personalized data item table from a first data source,
a data item attribute manager configured to obtain data item attribute information associated with the personalized data item table from a second data source, and
a test view generator configured to generate a test view associated with the personalized data item table, the test view including a graphical representation of the data item attribute information displayed in accordance with the table layout information.

2. The system of claim 1 wherein the personalized table manager further comprises:
a communication item view generator configured to generate a communication item view associated with the personalized data item table, the communication item view including a graphical representation of values of one or more data items associated with the data item attribute information displayed in accordance with the table layout information.

3. The system of claim 1 wherein the personalized table manager further comprises:
a communication item view generator configured to generate a communication item view associated with the personalized data item table, the communication item view including a graphical representation of values of one or more data items associated with the data item attribute information displayed in accordance with the table layout information based on retrieving and processing the values, the table layout information, and the data item attribute information, and
a personalized communication item manager configured to provide a personalized communication item including the communication item view.

4. The system of claim 1 wherein:
the table layout manager is configured to obtain the table layout information associated with the personalized data item table from a first application,
the data item attribute manager is configured to obtain the data item attribute information associated with the personalized data item table from a second application, and
the test view generator is configured to generate the test view associated with the personalized data item table, the test view including a graphical representation of the data item attribute information displayed in accordance with the table layout information, based on retrieving and processing the table layout information and the data item attribute information.

5. The system of claim 1 wherein:
the table layout manager is configured to obtain the table layout information based on obtaining one or more table format attribute values, including one or more of a table border format attribute, a cell padding format attribute, a font attribute, an alignment attribute, a color attribute, or a size attribute associated with the personalized data item table, from a first application,
the data item attribute manager is configured to obtain the data item attribute information based on obtaining one or more data item attributes, including one or more of a data item identifier (ID), a data item description, a data item category, a data item category type, or a data item price associated with data items associated with the personalized data item table, from a second application, and
the test view generator is configured to generate the test view associated with the personalized data item table, the test view including a graphical representation of the data item attribute information displayed in accordance with the table layout information, based on retrieving and processing the table layout information and the data item attribute information.

6. The system of claim 1 wherein:
the table layout manager is configured to obtain the table layout information based on obtaining table layout information associated with a personalized product table from a first application,
the data item attribute manager is configured to obtain the data item attribute information based on obtaining product attribute information associated with the personalized product table from a second application, and
the test view generator is configured to generate the test view based on generating a test view associated with the personalized product table, the test view including a graphical representation of the product attribute information displayed in accordance with the table layout information, based on retrieving and processing the table layout information and the product attribute information.

7. The system of claim 1 wherein the personalized table manager further comprises:
a table layout update manager configured to obtain updated table layout information via a table layout user interface application; and
a test view update generator configured to generate an updated test view associated with the personalized data item table, the updated test view including a graphical representation of the data item attribute information displayed in accordance with the updated table layout information.

8. The system of claim 1 wherein the personalized table manager further comprises:
a data item attribute information update manager configured to obtain updated data item attribute information via a data item attribute user interface application; and
a test view update generator configured to generate an updated test view associated with the personalized data item table, the updated test view including a graphical representation of the data item attribute information displayed in accordance with the updated data item attribute information.

9. A method comprising:
obtaining table layout information associated with a personalized data item table from a first data source;
obtaining data item attribute information associated with the personalized data item table from a second data source; and
generating a test view associated with the personalized data item table, the test view including a graphical representation of the data item attribute information displayed in accordance with the table layout information.

10. The method of claim 9 and further comprising:
generating a communication item view associated with the personalized data item table, the communication item view including a graphical representation of values of one or more data items associated with the data item attribute information displayed in accordance with the table layout information.

11. The method of claim 9 and further comprising:
generating a communication item view associated with the personalized data item table, the communication item view including a graphical representation of values of one or more data items associated with the data item attribute information displayed in accordance with the table layout information based on retrieving and processing the values, the table layout information, and the data item attribute information; and
providing a personalized communication item including the communication item view.

12. The method of claim 9 wherein:
obtaining the table layout information includes obtaining table layout information associated with the personalized data item table from a first application;
obtaining the data item attribute information includes obtaining data item attribute information associated with the personalized data item table from a second application; and
generating the test view includes generating a test view associated with the personalized data item table, the test view including a graphical representation of the data item attribute information displayed in accordance with the table layout information, based on retrieving and processing the table layout information and the data item attribute information.

13. The method of claim 9 wherein:
obtaining the table layout information includes obtaining one or more table format attribute values, including one or more of a table border format attribute, a cell padding format attribute, a font attribute, an alignment attribute, a color attribute, or a size attribute associated with the personalized data item table, from a first application;
obtaining the data item attribute information includes obtaining one or more data item attributes, including one or more of a data item identifier (ID), a data item description, a data item category, a data item category type, or a data item price associated with data items associated with the personalized data item table, from a second application; and
generating the test view includes generating a test view associated with the personalized data item table, the test view including a graphical representation of the data item attribute information displayed in accordance with the table layout information, based on retrieving and processing the table layout information and the data item attribute information.

14. The method of claim 9 wherein:
obtaining the table layout information includes obtaining table layout information associated with a personalized product table from a first application;
obtaining the data item attribute information includes obtaining product attribute information associated with the personalized product table from a second application; and
generating the test view includes generating a test view associated with the personalized product table, the test view including a graphical representation of the product attribute information displayed in accordance with the table layout information, based on retrieving and processing the table layout information and the product attribute information.

15. The method of claim 9 and further comprising:
obtaining updated table layout information via a table layout user interface application; and
generating an updated test view associated with the personalized data item table, the updated test view including a graphical representation of the data item attribute information displayed in accordance with the updated table layout information.

16. The method of claim 9 and further comprising:
obtaining updated data item attribute information via a data item attribute user interface application; and
generating an updated test view associated with the personalized table, the updated test view including a graphical representation of the updated data item attribute information displayed in accordance with the data item attribute information.

17. A computer program product being tangibly embodied on a computer-readable medium and being configured to cause a data processing apparatus to:
obtain table layout information associated with a personalized data item table from a first data source;
obtain data item attribute information associated with the personalized data item table from a second data source; and
generate a test view associated with the personalized data item table, the test view including a graphical representation of the data item attribute information displayed in accordance with the table layout information.

18. The computer program product of claim 17, further configured to cause the data processing apparatus to:
generate a communication item view associated with the personalized data item table, the communication item view including a graphical representation of values of one or more data items associated with the data item attribute information displayed in accordance with the table layout information.

19. The computer program product of claim 17, further configured to cause the data processing apparatus to:
generate a communication item view associated with the personalized data item table, the communication item view including a graphical representation of values of one or more data items associated with the data item attribute information displayed in accordance with the table layout information based on retrieving and processing the values, the table layout information, and the data item attribute information, and
provide a personalized communication item including the communication item view.

20. The computer program product of claim 17, further configured to cause the data processing apparatus to:
obtain updated table layout information via a table layout user interface application, and
generate an updated test view associated with the personalized data item table, the updated test view including a graphical representation of the data item attribute information displayed in accordance with the updated table layout information.
